(19) United States
(12) Patent Application Publication
(10) Pub. No.: US 2026/0215457 A1
(43) Pub. Date: Jul. 30, 2026

(54) MEAT-LIKE FOOD, METHOD FOR PRODUCING SAME, AND METHOD FOR IMPROVING APPEARANCE OF MEAT-LIKE FOOD

(71) Applicant: Nisshin Seifun Group Inc., Tokyo (JP)

(72) Inventors: Nozomi SHATARI, Fujimino-shi (JP); Masashi YOSHIDA, Fujimino-shi (JP); Shinya TOKUDA, Fujimino-shi (JP); Kenji NAKAMURA, Fujimino-shi (JP)

(73) Assignee: Nisshin Seifun Group Inc., Tokyo (JP)

(21) Appl. No.: 19/145,387

(22) PCT Filed: Sep. 24, 2024
(86) PCT No.: PCT/JP2024/033856

§ 371 Date: Jul. 2, 2025

(30) Foreign Application Priority Data
Sep. 29, 2023 (JP) 2023-169893

(51) Int. Cl. A23J 3/14; A23J 3/22; A23J 3/26; A23L 29/00

(52) U.S. Cl. CPC A23J 3/14; A23J 3/227; A23J 3/26; A23L 29/015

(57) ABSTRACT

An objective of the invention is to provide a meat-like food product having an appearance and flavor/texture similar to that of livestock meat, despite using a vegetable protein. A first invention is a meat-like food product containing: a vegetable protein; and at least one type of visual effect improving agent selected from Maillard reaction inhibiting agents and light scattering agents, wherein, in an uncooked state, the meat-like food product has a moisture content of from 40 to 90 mass % and an L* value of from 60 to 95. A second invention is a meat-like food product containing: a vegetable protein; and at least one type of visual effect improving agent selected from Maillard reaction inhibiting agents and light scattering agents, wherein, in an uncooked state, the meat-like food product has a moisture content of from 40 to 90 mass %, and the meat-like food product has a larger L* value in an uncooked state compared to a control product, and a difference in L* value between the meat-like food product and the control product is from 2 to 30, the control product being an uncooked product that does not contain the visual effect improving agent, contains water and the same type of vegetable protein as the vegetable protein contained in the meat-like food product, and has the same moisture content as the meat-like food product.

### TECHNICAL FIELD

The present invention relates to a meat-like food product containing a vegetable protein and being useful as a meat substitute.

### BACKGROUND ART

Conventionally, vegetable proteins, which are proteins derived from plants such as soybean, wheat, etc., have been used as raw materials for processed food products. Particularly in recent years, issues such as global population increase, environmental burden accompanying animal husbandry, etc. are being highlighted, and as a means for solving such issues, processed food products that may serve as substitutes for livestock meat are gaining attention, and meat-like food products, which are mainly constituted by vegetable protein, have been proposed as such processed food products.

Patent Literature 1 discloses, as a type of meat-like food product, a colored structured protein product containing vegetable protein and a colorant. The colored structured protein product is obtained by extruding a raw material containing the vegetable protein and the colorant using an extruder, wherein the moisture content of the vegetable protein at the time of extrusion is preferably from 1 to 35 wt %. It is described that the colored structured protein product has the same texture characteristics as animal meat.

Patent Literature 2 discloses a food analog containing meat such as livestock meat etc., a flour such as wheat flour etc., and a colorant such as natural colors, titanium dioxide, etc., and having an appearance that represents real natural foods. Patent Literature 3 discloses a food analog containing fish meat protein, water, and a colorant, and having a realistic flaked fish-like appearance and texture. The food analogs disclosed in Patent Literatures 2 and 3 both include real meat, such as livestock meat, fish meat, etc., and Patent Literatures 2 and 3 describe nothing specific regarding food products oriented toward using only vegetable protein as the protein.

### CITATION LIST

### Patent Literature

Patent Literature 1: US 2008/0254199 A1
Patent Literature 2: WO 2012/103056
Patent Literature 3: WO 2010/126563

### SUMMARY OF INVENTION

An objective of the present invention is to provide a meat-like food product having an appearance and flavor/texture similar to that of livestock meat, despite using a vegetable protein.

The present invention (first inventive product) relates to a meat-like food product containing: a vegetable protein; and at least one type of visual effect improving agent selected from Maillard reaction inhibiting agents and light scattering agents, wherein in an uncooked state, the meat-like food product has a moisture content of from 40 to 90 mass % and an L* value of from 60 to 95.

Further, the present invention (second inventive product) relates to a meat-like food product containing: a vegetable protein; and at least one type of visual effect improving agent selected from Maillard reaction inhibiting agents and light scattering agents, wherein in an uncooked state, the meat-like food product has a moisture content of from 40 to 90 mass %, and the meat-like food product has a larger L* value in an uncooked state compared to a control product, and a difference in L* value between the meat-like food product and the control product is from 2 to 30, the control product being an uncooked product that does not contain the visual effect improving agent, contains water and the same type of vegetable protein as the vegetable protein contained in the meat-like food product, and has the same moisture content as the meat-like food product.

Further, the present invention relates to a method for producing the aforementioned meat-like food product of the invention, the method including a step of extruding, using an extruder, a raw material containing the vegetable protein, the visual effect improving agent, and water.

Further, the present invention relates to a method for improving appearance of a meat-like food product containing a vegetable protein and having a moisture content of from 40 to 90 mass % in an uncooked state, the method including: mixing, to the meat-like food product, at least one type of visual effect improving agent selected from Maillard reaction inhibiting agents and light scattering agents, to increase an L* value of the meat-like food product in an uncooked state by 2 to 30 compared to a state in which the visual effect improving agent has not been mixed.

### DESCRIPTION OF EMBODIMENTS

A meat-like food product of the present invention contains a vegetable protein. Herein, “vegetable protein” refers to a protein obtained from a plant. A supply source of the vegetable protein may include, for example, beans (soybean, adzuki (red) beans, etc.), cereals (wheat, barley, rice, com, buckwheat, etc.), potatoes (white potato, etc.), seeds and nuts (peanuts, almonds, etc.), algae, etc. The vegetable protein may be treated such as by enzyme. In the meat-like food product of the present invention, one type of vegetable protein may be used singly, or two or more types may be used in combination.

Examples of vegetable proteins suitable for the present invention may include bean proteins in which beans are the supply source, and cereal proteins in which cereals (or cereal-derived powders) are the supply source. Concrete examples of bean proteins may include soybean protein (e.g., pressed soybean powder, concentrated soybean protein, separated soybean protein, extracted soybean protein), green pea protein, broad bean protein, chickpea protein, green gram protein, etc. Concrete examples of cereal proteins may include wheat protein such as gluten etc., rice protein, oat protein, rapeseed protein, potato protein, etc.

The content of the vegetable protein in the meat-like food product of the present invention is not particularly limited, but from the viewpoint of more reliably achieving the objective of providing a meat-like food product that is useful as a meat substitute, it is preferable that the content is 10 mass % or greater, more preferably 20 mass % or greater, possibly 40 mass % or greater, with respect to the total mass of the meat-like food product.

The meat-like food product of the present invention has a feature of containing at least one type of visual effect improving agent selected from Maillard reaction inhibiting agents and light scattering agents. In this way, the meat-like food product of the present invention will exhibit a color similar to the color of livestock meat when visually observed and will have an appearance close to the appearance of livestock meat. Herein, “livestock meat” is as described above.

As is known in the art, a “Maillard reaction” is a reaction in which protein nonenzymatically reacts with a reducing sugar such as glucose, to produce a brown colorant as a glycated product, and is a typical nonenzymatic browning reaction of food products. According to the Inventors' finding, production by heating of a meat-like food product containing a vegetable protein is likely to promote browning due to the Maillard reaction compared to livestock meat, and thus, when observed visually after production by heating, the meat-like food product may exhibit a stronger brownish color compared to livestock meat and may have an appearance different from livestock meat. Therefore, in the present embodiment, a Maillard reaction inhibiting agent is mixed, as a visual effect improving agent, to the meat-like food product containing a vegetable protein with the aim of improving visual effects (i.e., reducing brownish color) by inhibiting the Maillard reaction.

Further, a light scattering agent is a substance having a high refractive index and having a property (light scattering property) of physically reflecting and scattering light emitted from a light source. According to the Inventors' finding, by mixing a light scattering agent to the meat-like food product containing a vegetable protein, light scattering properties are imparted to the meat-like food product and visual effects are improved. Thus, the meat-like food product will have an appearance close to the appearance of livestock meat when observed visually using natural light or artificial light.

Examples of Maillard reaction inhibiting agents usable for the visual effect improving agent may include organic acids, vitamins, polyphenols, amino acids, and reducing agents. One type thereof may be used singly, or two or more types may be used in combination.

Concrete examples of organic acids may include citric acid, malic acid, lactic acid, phytic acid, gluconic acid, and fumaric acid.

Concrete examples of vitamins may include vitamin B and vitamin E.

Concrete examples of polyphenols may include catechin, mangosteen extract, and rosemary extract.

A concrete example of an amino acid may include L-cystine.

Concrete examples of reducing agents may include sodium pyrosulfite and sodium sulfite.

Examples of light scattering agents usable for the visual effect improving agent may include inorganic salts. One type thereof may be used singly, or two or more types may be used in combination.

Concrete examples of inorganic salts may include titanium dioxide, calcium carbonate, and magnesium carbonate.

The content of the visual effect improving agent in the meat-like food product of the present invention can be adjusted as appropriate depending on, for example, the type of visual effect improving agent to be used, with consideration given to the balance between advantages of using the visual effect improving agent (improvement of visual effects of the meat-like food product) and disadvantages (e.g., degradation of flavor/texture of the meat-like food product).

In cases of using a Maillard reaction inhibiting agent, typified by the aforementioned concrete examples, as the visual effect improving agent, the content of the Maillard reaction inhibiting agent in the meat-like food product of the present invention is preferably from 0.01 to 3 mass %, more preferably from 0.1 to 2 mass %, with respect to the total mass of the meat-like food product.

In cases of using a light scattering agent, typified by the aforementioned concrete examples, as the visual effect improving agent, the content of the light scattering agent in the meat-like food product of the present invention is preferably from 0.01 to 3 mass %, more preferably from 0.1 to 2 mass %, with respect to the total mass of the meat-like food product.

The meat-like food product of the present invention needs to have a moisture content of from 40 to 90 mass % in an uncooked state. Herein, “uncooked state” refers to a state in which the meat-like food product has not been subjected to cooking that may substantially affect the moisture content of the meat-like food product. Examples of “cooking that may substantially affect the moisture content of the meat-like food product” may include: washing of the meat-like food product using a liquid; cooking by heating, such as deep-frying, boiling, grilling, etc.; and cooking of the meat-like food product using a liquid, such as marinating (a treatment of immersing the meat-like food product in a liquid), coating (a treatment of coating the surface of the meat-like food product with a liquid), etc. For example, cutting the meat-like food product with cookware such as a kitchen knife generally falls under “cooking of the meat-like food product”, but usually, cutting does not substantially affect the moisture content of the meat-like food product, so the meat-like food product that has only been cut can be said as being in an “uncooked state”.

In the present invention, the “moisture content of the meat-like food product” is a moisture content measured according to the absolute dry method. More specifically, the moisture content is calculated as a ratio between: the mass when a constant weight has been reached by heating the meat-like food product to be measured in a condition where the product temperature reaches 130° C.; and the mass before the meat-like food product is heated.

The moisture content of the meat-like food product primarily affects the texture and color of the meat-like food product. If the moisture content of the meat-like food product is below 40 mass %, the texture may become harder and the color may become darker compared to that of livestock meat, whereas if the moisture content exceeds 90 mass %, the texture may become softer and the color may become lighter compared to that of livestock meat, and in either case, the texture and color of the meat-like food product may significantly deviate from that of livestock meat. From the viewpoint of achieving the predetermined effects of the present invention more reliably, it is preferable that the moisture content of the meat-like food product of the present invention is preferably from 40 to 95 mass %, more preferably from 50 to 80 mass %.

Adjustment of the moisture content of the meat-like food product can be achieved, for example, by adjusting the amount of water to be added to the raw material containing the vegetable protein at the time of producing the meat-like food product.

In an uncooked state, the meat-like food product of the present invention: (1) has an L* value of from 60 to 95 (also referred to hereinafter as “Feature 1”); or (2) has a larger L* value than a control product, and the difference in the L* value between the meat-like food product and the control product (also referred to hereinafter as “L* value difference”) is from 2 to 30 (also referred to hereinafter as “Feature 2”). Herein, “uncooked state” is as described above.

As regards the Feature 2, the control product serving as a comparison target for the meat-like food product of the present invention is a food product in the aforementioned “uncooked state”, i.e., an uncooked product that does not contain the visual effect improving agent (the Maillard reaction inhibiting agent or the light scattering agent), contains water and the same type of vegetable protein as the vegetable protein contained in the meat-like food product, and has the same moisture content as the meat-like food product. The control product can be produced according to the same method for producing the meat-like food product to be compared, except that no visual effect improving agent is used as a raw material. In cases where only the visual effect improving agent can be removed from the meat-like food product to be compared, the control product may be produced by removing the same.

The L* value of the control product varies depending on the type of vegetable protein, the content of the vegetable protein, etc., but is typically from 55 to 65 in cases where the aforementioned type of vegetable protein is included in the aforementioned amount.

The L* value can be measured according to an ordinary method by using a measurement device (e.g., colorimeter) capable of measuring and converting colors into numerical form. A concrete example of such a measurement device may be an “IRIS Visual Analyzer” from Alpha M.O.S. Japan K.K. The surface of the meat-like food product is where the L* value is measured in the meat-like food product.

As known in the art, the L* value represents the lightness of a substance (meat-like food product) and is indicated in numerical values from 0 to 100. The larger the L* value, the lighter the color of the substance and the closer it is to white, whereas the smaller the L* value, the darker the color of the substance and the closer it is to black. The meat-like food product of the present invention having one or both of the aforementioned Features 1 and 2 has a color similar to that of livestock meat, and can thus have an appearance similar to livestock meat.

The meat-like food product of the present invention having the aforementioned Feature 1 has an L* value of preferably from 65 to 95, more preferably from 70 to 95.

The meat-like food product of the present invention having the aforementioned Feature 2 has an L* value difference of preferably from 3 to 30, more preferably from 5 to 30.

Adjustment of the L* value of the meat-like food product can be achieved, for example, by adjusting the type of vegetable protein, the type of visual effect improving agent, the content of the visual effect improving agent in the meat-like food product, etc.

Concrete examples of livestock meat having a color particularly similar to the color of the meat-like food product of the present invention may include the following. The meat-like food product of the present invention is particularly useful as meat substitutes for the following types of meat. Note that “deep-fried chicken” and “deep-fried pork” described below are obtained by first attaching a coating material to the surface of chicken or pork and then deep-frying the same in oil at a high temperature, and thus have a coating attached to the meat surface. Therefore, the L* value thereof refers to the L* value of the meat surface measured after peeling off the coating and exposing the meat surface.
Deep-fried chicken (L* value: around 92.1 to 95.3)
Deep-fried pork (L* value: around 78.6 to 79.3)
Boiled chicken (L* value: around 92.7 to 93.1)
Boiled pork (L* value: around 76.9 to 80.5)
Grilled chicken (L* value: around 92.7 to 93.2)
Grilled pork (L* value: around 75.4 to 78.3)

The meat-like food product of the present invention may contain other components, other than the aforementioned components (the vegetable protein, the visual effect improving agent, and water), to an extend that achievement of predetermined effects of the present invention (i.e., capability of providing a meat-like food product having an appearance and flavor/texture similar to that of livestock meat while using a vegetable protein) is not inhibited. Examples of such other components may include animal proteins, starches, polysaccharides, dietary fibers, edible oils and fats, seasonings, colorants, aroma flavorings, emulsifiers, etc. One type of the above may be used singly, or two or more types may be used in combination.

The aforementioned “animal protein” refers to a protein obtained from an animal. Examples of supply sources of animal proteins may include livestock meat, poultry, seafood, insects, eggs, milk, etc. The animal protein may be treated with an enzyme etc.

From the viewpoint of more reliably achieving the objective of providing a meat-like food product that is useful as a meat substitute, it is preferable that the content of vegetable protein with respect to proteins contained in the meat-like food product of the present invention is preferably 50 mass % or greater, more preferably 75 mass % or greater. All of the protein contained in the meat-like food product of the present invention may be vegetable protein.

In an uncooked state, the meat-like food product of the present invention has a pH of preferably from 5.9 to 7.0, more preferably from 6.2 to 7.0. When the pH of the meat-like food product is within this preferable range, the flavor becomes even more similar to that of livestock meat. Cases in which the pH of the meat-like food product particularly becomes an issue are where an organic acid is used as a Maillard reaction inhibiting agent (visual effect improving agent). In such cases, the pH of the meat-like food product may fall below the aforementioned preferable range, and the flavor of the meat-like food product may greatly differ from that of livestock meat, e.g., the sourness of the meat-like food product may become too strong. So, in cases of using an organic acid, it is preferable to adjust the type and/or content of the organic acid such that the pH of the meat-like food product in a state containing the organic acid falls within the aforementioned preferable range. The pH of the meat-like food product may be adjusted by using a pH adjusting agent. For the pH adjusting agent, any type usable in food products can be used without particular limitation.

The pH of the meat-like food product is measured according to the following method. With respect to the meat-like food product to be measured, 10 times the mass thereof of ion exchanged water is added, and a mixed liquid is prepared by stirring with a mixer. The pH of the mixed liquid at a liquid temperature of 25° C. is measured with a pH meter (e.g., “LAQUA-PH-SE” from Horiba, Ltd.), and the measurement value is found as the pH of the meat-like food product.

Note that, although the meat-like food product of the present invention is typically obtained by extruding a raw material containing a vegetable protein and a visual effect improving agent as described below, the pH of the raw material substantially does not change before and after extrusion. Therefore, the pH of the raw material before being extruded may be measured according to the aforementioned method, and that measurement value may be considered the pH of the meat-like food product, which is an extruded product of the raw material.

The meat-like food product of the present invention is typically obtained by extruding a raw material containing a vegetable protein, a visual effect improving agent, and water. A method for producing the meat-like food product of the present invention may involve a step of using an extruding machine (extruder) to extrude the raw material (also referred to hereinafter as “extrusion step”).

The extruder typically includes: a hollow tubular cylinder (barrel) having in its interior a flow path for the raw material; a screw that is arranged in the flow path and is driven to rotate by a drive source such as a motor; and a feeder that supplies the raw material to the flow path. A heating means such as a heater may be arranged around the cylinder so that the raw material inside the flow path can be heated. Steam may be introduced into the flow path. The extruder may be a uniaxial extruder having a single screw, or may be a biaxial extruder having two screws. A cooling die for cooling the raw material (extruded product) that has been extruded from the extruder may be connected to the downstream end in the extruding direction of the extruder. For the cooling die, any known type may be used without particular limitation.

In the extrusion step, typically, a material obtained by adding water to the raw material (excluding water) constituted by a vegetable protein and a visual effect improving agent is subjected to extrusion. The vegetable protein and the visual effect improving agent are typically in powder form at ordinary temperature and ordinary pressure. The amount of water added to the raw material excluding water is preferably from 50 to 250 parts by mass, more preferably from 60 to 200 parts by mass, with respect to 100 parts by mass of the raw material excluding water from the viewpoint of adjusting the moisture content of the meat-like food product to 40 to 90 mass % as described above.

In the extrusion step, it is preferable to heat the raw material at the time of extruding the raw material. The heating temperature at the time of extruding the raw material is not particularly limited, but from the viewpoint of more reliably achieving predetermined effects of the present invention, it is preferable that the product temperature of the raw material at the downstream end, in the extruding direction, of the extruder used for extrusion is adjusted preferably within a range from 120 to 200° C., more preferably from 140 to 180° C.

In the extrusion step, the pressure for extruding the raw material is not particularly limited, but from the viewpoint of more reliably achieving predetermined effects of the present invention, it is preferable that the extrusion pressure at the downstream end, in the extruding direction, of the extruder used for extrusion is adjusted preferably within a range from 0.5 to 10.0 MPa, more preferably from 1.0 to 5.0 MPa.

In the extrusion step, the temperature for cooling the extruded product with a cooling means, such as a cooling die etc., is not particularly limited, but from the viewpoint of preventing expansion of the extruded product, it is preferable that the product temperature of the extruded product immediately after cooling with the cooling means (e.g., the product temperature of the extruded product immediately after being pressed out from the cooling die) is adjusted preferably within a range from 30 to 95° C., more preferably from 40 to 80° C.

The meat-like food product of the present invention may be subjected to a heating treatment, such as retort sterilization etc., with the aim of sterilization etc. Further, the meat-like food product of the present invention may be subjected to refrigeration or frozen storage. A freeze-stored meat-like food product of the present invention is usually thawed before use.

The meat-like food product of the present invention can be eaten as-is without being cooked, or can be eaten after being subjected to cooking by heating, such as deep-frying, boiling, grilling, etc., or cooking using a liquid, such as marinating, coating, etc. Further, the meat-like food product of the present invention can be used for various processed food products. For example, by using the meat-like food product of the present invention as a material for a processed food product that does not contain livestock meat such as beef, pork, chicken, etc., the processed food product can be provided with a texture close to the texture of livestock meat, and the processed food product can serve as a meat-like food product usable as a meat substitute. The meat-like food product of the present invention can also be blended to a processed food product containing livestock meat.

The present invention encompasses a method for improving appearance of a meat-like food product (also referred to hereinafter as “improvement-target food product”) containing a vegetable protein and having a moisture content of from 40 to 90 mass % in an uncooked state. The method for improving appearance of a meat-like food product according to the present invention has a feature of mixing, to the improvement-target food product, at least one type of visual effect improving agent selected from Maillard reaction inhibiting agents and light scattering agents, to increase the L* value of the improvement-target food product in an uncooked state by 2 to 30, preferably 3 to 30, more preferably 5 to 30, compared to a state in which the visual effect improving agent has not been mixed.

The explanation regarding the aforementioned meat-like food product of the present invention and method for producing the same applies as appropriate to features that are not particularly explained regarding the method for improving appearance of a meat-like food product according to the present invention.

As for the vegetable protein to be used in the improvement-target food product, it is possible to use, without particular limitation, the vegetable protein usable in the aforementioned meat-like food product of the present invention.

The content of the vegetable protein in the improvement-target food product is not particularly limited, but from the viewpoint of making the improvement-target food product useful as a meat substitute, the content is preferably 20 mass % or greater, more preferably 60 mass % or greater, with respect to the total mass of the improvement-target food product.

From the viewpoint of improving texture and improving the similarity to livestock meat in terms of appearance properties such as color, the moisture content in the improvement-target food product is preferably from 40 to 95 mass %, more preferably from 50 to 80 mass %.

As for the visual effect improving agent (the Maillard reaction inhibiting agent and/or light scattering agent) to be mixed to the improvement-target food product, it is possible to use, without particular limitation, the visual effect improving agent usable in the aforementioned meat-like food product of the present invention.

In cases of using a Maillard reaction inhibiting agent as the visual effect improving agent, it is preferable that the amount of mixture of the Maillard reaction inhibiting agent to the improvement-target food product is adjusted such that the content of the Maillard reaction inhibiting agent in the improvement-target food product, to which the Maillard reaction inhibiting agent has been mixed, is preferably from 0.01 to 3 mass %, more preferably from 0.1 to 2 mass %, with respect to the total mass of the improvement-target food product.

In cases of using a light scattering agent as the visual effect improving agent, it is preferable that the amount of mixture of the light scattering agent to the improvement-target food product is adjusted such that the content of the light scattering agent in the improvement-target food product, to which the light scattering agent has been mixed, is preferably from 0.01 to 3 mass %, more preferably from 0.1 to 2 mass %, with respect to the total mass of the improvement-target food product.

The method for mixing the visual effect improving agent to the improvement-target food product is not particularly limited, and for example, the visual effect improving agent may be attached to the surface of the improvement-target food product to which the visual effect improving agent has not yet been mixed, but typically, a method is adopted wherein the visual effect improving agent is mixed as a raw material (e.g., a raw material in the aforementioned extrusion step) at the time of producing the improvement-target food product.

### EXAMPLES

The present invention will be described in further detail below according to Examples thereof, but the present invention is not limited to the following Examples.

### Examples 1 to 31 and Comparative Examples 1 and 2: Production of Meat-Like Food Product

Meat-like food products were each produced by extruding, with a biaxial extruder, a material obtained by adding water to powder materials having the respective compositional makeup shown in Tables 1 to 3 below. The biaxial extruder had a typical configuration, and a cooling die was connected to the downstream end of the biaxial extruder in the extruding direction, to enable the material extruded from the biaxial extruder to be cooled with the cooling die. Details of vegetable proteins used as the powder materials and of the extrusion conditions are as described below.

The meat-like food product of Comparative Example 1 is a comparison target for the meat-like food products of Examples 1 to 24. The meat-like food product of Comparative Example 2 is a comparison target for the meat-like food products of Examples 25 to 31. Comparative Examples 1 and 2 both correspond to the “control product” described in the aforementioned Feature 2.

### Vegetable Proteins:

Soybean protein: “Fujipro CA” from Fuji Oil Co., Ltd.; protein content, anhydrous basis: 90 mass % or greater
Wheat protein: “WEIPRO” from Jacker Muhlen-und Nahrmittelwerke GmbH; protein content, anhydrous basis: 72 mass % or greater
Green pea protein: “NUTRALYS S85F” from Roquette Japan K.K.; protein content, anhydrous basis: 85 mass % or greater

### Extrusion Conditions:

Heating temperature: Adjusted such that the temperature at the downstream end of the extruder's cylinder in the extruding direction was 150° C., and the product temperature of the raw material at the downstream end of the extruder in the extruding direction was from 140 to 180° C.
Extrusion pressure (extrusion pressure at the downstream end of the extruder in the extruding direction): 1.0 to 5.0 MPa
Cooling temperature: Adjusted such that the product temperature of the extruded product (meat-like food product) immediately after being extruded from the cooling die was from 40 to 80° C.

### Evaluation Tests:

The L* value of the meat-like food product being evaluated (the L* value of the uncooked meat-like food product) was measured using “IRIS Visual Analyzer” from Alpha M.O.S. Japan K.K. in L*a*b* mode, and the L* value difference of the meat-like food product of each Example (the L* value difference of the uncooked meat-like food product) was calculated by employing Comparative Example 1 or 2 as the “control product”.

Further, the meat-like food product being evaluated was deep-fried, to produce a deep-fried food, and the L* value of the deep-fried food was measured. More specifically, 100 g of the meat-like food product was formed into a predetermined shape, the entire surface of the shaped product was coated with a liquid batter containing wheat flour (coating material), and this was placed in edible oil at an oil temperature of 170° C. and deep-fried for 2 minutes, to produce a deep-fried food. Then, the coating was peeled off from the deep-fried food to expose the surface of the meat-like food product, and the L* value of the surface of the exposed portion (the L* value of the deep-fried meat-like food product) was measured according to the aforementioned method.

Further, ten expert panelists evaluated the production stability of each meat-like food product, as well as the appearance (appearance with the coating peeled off) and texture of the deep-fried food, according to the following evaluation criteria. The results (arithmetic mean value of the scores of the ten panelists) are shown in Tables 1 to 3 below.

In the following evaluation criteria, “deep-fried chicken breast meat” was obtained by producing a deep-fried food according to the aforementioned method, except that chicken breast meat (livestock meat) was used instead of the meat-like food product, and peeling off the coating from the deep-fried food to expose the chicken breast meat. The L* value was 93.5.

### Criteria for Evaluation of Appearance:

5 points: Very good; has a color (whiteness) of the same level as deep-fried chicken breast meat, and has an appearance extremely similar to deep-fried chicken breast meat.
4 points: Good; has a color (whiteness) close to deep-fried chicken breast meat, and has an appearance considerably similar to deep-fried chicken breast meat.
3 points: Acceptable level; has a color (light brown color) different from deep-fried chicken breast meat, but has an appearance similar to deep-fried chicken breast meat.
2 points: Poor; has a color (slightly dull brown color) different from deep-fried chicken breast meat, and has an appearance that is not so similar to deep-fried chicken breast meat.
1 point: Very poor; has a color (dull brown color) different from deep-fried chicken breast meat, and has an appearance that is not similar to deep-fried chicken breast meat.

### Criteria for Evaluation of Texture:

5 points: Very good; the texture is substantially the same as that of deep-fried chicken breast meat, and more specifically, is extremely soft and dissolves very easily while having a rich fibrous texture.
4 points: Good; the texture is close to that of deep-fried chicken breast meat, and more specifically, is soft and dissolves easily while having a sufficient fibrous texture.
3 points: Acceptable level; the texture is somewhat different from that of deep-fried chicken breast meat, and more specifically, is somewhat soft and dissolves easily while having a fibrous texture.
2 points: Poor; the texture is different from that of deep-fried chicken breast meat, and more specifically, is considerably hard, or somewhat lacking in fibrous texture, or somewhat difficult to dissolve although having a fibrous texture.
1 point: Very poor; the texture is considerably different from that of deep-fried chicken breast meat, and more specifically, is extremely hard, or lacking in fibrous texture, or extremely difficult to dissolve although having a fibrous texture.

### Criteria for Evaluation of Production Stability:

A: Good; the extruded product (meat-like food product) is discharged stably from the discharge outlet of the cooling die.
B: Practically acceptable level, although discharging of the extruded product (meat-like food product) from the discharge outlet of the cooling die undergoes pulsing motion, and the extruded product sometimes bursts out from the discharge outlet.

TABLE 1

| | | | | Compar- | | | | | | | | |
|---|---|---|---|---|---|---|---|---|---|---|---|---|
| | | | | ative | | | | | | | | |
| | | | | Example | Example | | | | | | | |
| | | | | 1 | 1 | 2 | 3 | 4 | 5 | 6 | 7 | 8 |
| Powder | Vegetable | Soy bean protein | | 60 | 60 | 60 | 60 | 60 | 60 | 60 | 60 | 60 |
| materials | protein | Wheat protein | | 40 | Balance | Balance | Balance | Balance | Balance | Balance | Balance | Balance |
| (parts by | Maillard | Organic | Citric acid | | 1 | 0.5 | 0.10 | | | | | |
| mass) | reaction | acids | Malic acid | | | | | 1 | | | | |
| | inhibiting | | Lactic acid | | | | | | 1 | | | |
| | agent | | Phytic acid | | | | | | | 1 | | |
| | | | Gluconic | | | | | | | | 1 | |
| | | | acid | | | | | | | | | |
| | | | Fumaric | | | | | | | | | 1 |
| | | | acid | | | | | | | | | |
| | | Vitamins | Vitamin E | | | | | | | | | |
| | | | Vitamin B | | | | | | | | | |
| | | Polyphenols | Catechin | | | | | | | | | |
| | | | Mangosteen | | | | | | | | | |
| | | | extract | | | | | | | | | |
| | | | Rosemary | | | | | | | | | |
| | | | extract | | | | | | | | | |
| | | Amino | L-cystine | | | | | | | | | |
| | | acids | | | | | | | | | | |
| | | Reducing | Sodium | | | | | | | | | |
| | | agents | pyrosulfite | | | | | | | | | |
| | | | Sodium | | | | | | | | | |
| | | | sulfite | | | | | | | | | |
| | Total | | | 100 | 100 | 100 | 100 | 100 | 100 | 100 | 100 | 100 |
| Amount of water added to 100 parts by mass of | | | | 140 | 140 | 140 | 140 | 140 | 140 | 140 | 140 | 140 |
| powder materials (parts by mass) | | | | | | | | | | | | |
| Compositional | Vegetable protein | | | 42 | 41.58 | 41.79 | 41.958 | 41.58 | 41.58 | 41.58 | 41.58 | 41.58 |
| makeup of | Maillard reaction inhibiting agent | | | 0 | 0.42 | 0.21 | 0.042 | 0.42 | 0.42 | 0.42 | 0.42 | 0.42 |
| meat-like | Water (moisture content) | | | 58 | 58 | 58 | 58 | 58 | 58 | 58 | 58 | 58 |
| food product | Total | | | 100 | 100 | 100 | 100 | 100 | 100 | 100 | 100 | 100 |
| (mass %) | | | | | | | | | | | | |
| pH of uncooked meat-like food product | | | | 7.2 | 5.8 | 6.1 | 6.8 | 5.7 | 6.1 | 6.2 | 6.6 | 6.1 |
| L* value of uncooked meat-like food product | | | | 65.6 | 75.9 | 70.7 | 67.9 | 70.0 | 67.8 | 69.3 | 65.9 | 66.1 |
| L* value difference of uncooked meat-like food | | | | — | 10.3 | 5.1 | 2.3 | 4.4 | 2.2 | 3.7 | 0.3 | 0.5 |
| product | | | | | | | | | | | | |
| L* value of deep-fried meat-like food product | | | | 65.7 | 76.0 | 70.8 | 68.0 | 70.1 | 67.9 | 69.4 | 66.0 | 66.2 |
| Appearance of deep-fried meat-like food product | | | | 1.0 | 3.9 | 3.5 | 3.3 | 3.7 | 3.2 | 3.2 | 3.0 | 3.0 |
| (perfect score: 3 points) | | | | | | | | | | | | |
| Texture of deep-fried meat-like food product | | | | 3.5 | 4.5 | 4.3 | 4.0 | 3.8 | 4.0 | 3.9 | 3.6 | 3.6 |
| (perfect score: 5 points) | | | | | | | | | | | | |
| Production stability | | | | A | A | A | A | B | A | A | A | A |
| | | | | Example | | | | | | | | |
| | | | | 9 | 10 | 11 | 12 | 13 | 14 | 15 | 16 | |
| Powder | Vegetable | Soy bean protein | | 60 | 60 | 60 | 60 | 60 | 60 | 60 | 60 | |
| materials | protein | Wheat protein | | Balance | Balance | Balance | Balance | Balance | Balance | Balance | Balance | |
| (parts by | Maillard | Organic | Citric acid | | | | | | | | | |
| mass) | reaction | acids | Malic acid | | | | | | | | | |
| | inhibiting | | Lactic acid | | | | | | | | | |
| | agent | | Phytic acid | | | | | | | | | |
| | | | Gluconic | | | | | | | | | |
| | | | acid | | | | | | | | | |
| | | | Fumaric | | | | | | | | | |
| | | | acid | | | | | | | | | |
| | | Vitamins | Vitamin E | 1 | | | | | | | | |
| | | | Vitamin B | | 1 | | | | | | | |
| | | Polyphenols | Catechin | | | 1 | | | | | | |
| | | | Mangosteen | | | | 1 | | | | | |
| | | | extract | | | | | | | | | |
| | | | Rosemary | | | | | 1 | | | | |
| | | | extract | | | | | | | | | |
| | | Amino | L-cystine | | | | | | 1 | | | |
| | | acids | | | | | | | | | | |
| | | Reducing | Sodium | | | | | | | 0.01 | | |
| | | agents | pyrosulfite | | | | | | | | | |

| | |
|---|---|
| Sodium | 1 |
| sulfite | |

| | | | | | | | | |
|---|---|---|---|---|---|---|---|---|
| Total | 100 | 100 | 100 | 100 | 100 | 100 | 100 | 100 |

| Amount of water added to 100 parts by mass of | 140 | 140 | 140 | 140 | 140 | 140 | 140 | 140 |
|---|---|---|---|---|---|---|---|---|
| powder materials (parts by mass) | | | | | | | | |

| | | | | | | | | | |
|---|---|---|---|---|---|---|---|---|---|
| Compositional | Vegetable protein | 41.58 | 41.58 | 41.58 | 41.58 | 41.58 | 41.58 | 41.9958 | 41.58 |
| makeup of | Maillard reaction inhibiting agent | 0.42 | 0.42 | 0.42 | 0.42 | 0.42 | 0.42 | 0.0042 | 0.42 |
| meat-like | Water (moisture content) | 58 | 58 | 58 | 58 | 58 | 58 | 58 | 58 |
| food product | Total | 100 | 100 | 100 | 100 | 100 | 100 | 100 | 100 |
| (mass %) | | | | | | | | | |

| | | | | | | | | |
|---|---|---|---|---|---|---|---|---|
| pH of uncooked meat-like food product | — | — | — | — | — | — | — | — |
| L* value of uncooked meat-like food product | 74.1 | 70.9 | 68.1 | 68.2 | 67.7 | 67.9 | 72.6 | 69.0 |
| L* value difference of uncooked meat-like food | 8.5 | 5.3 | 2.5 | 2.6 | 2.1 | 2.3 | 7.0 | 3.4 |
| product | | | | | | | | |
| L* value of deep-fried meat-like food product | 74.2 | 71.0 | 68.2 | 68.3 | 67.0 | 68.0 | 72.7 | 69.1 |
| Appearance of deep-fried meat-like food product | 3.7 | 3.5 | 3.2 | 3.1 | 3.0 | 3.0 | 3.8 | 3.2 |
| (perfect score: 3 points) | | | | | | | | |
| Texture of deep-fried meat-like food product | 3.5 | 3.5 | 3.4 | 3.5 | 3.5 | 3.3 | 3.5 | 3.5 |
| (perfect score: 5 points) | | | | | | | | |
| Production stability | A | A | A | A | A | A | A | A |

Note 1:
“—” in the table indicates that no measurement was performed.

TABLE 2

| | | | Comparative | | | | | | | | |
|---|---|---|---|---|---|---|---|---|---|---|---|
| | | | Example | Example | | | | | | | |
| | | | 1 | 17 | 18 | 19 | 20 | 21 | 22 | 23 | 24 |
| Powder materials | Vegetable | Soy bean protein | 60 | 60 | 60 | 60 | 60 | 60 | 60 | 60 | 60 |
| (parts by mass) | protein | Wheat protein | 40 | Balance | Balance | Balance | Balance | Balance | Balance | Balance | Balance |
| | Maillard | Citric acid | | | | | | | 0.5 | | |
| | reaction | Catechin | | | | | | | | 1 | |
| | inhibiting | Sodium | | | | | | | | | 0.01 |
| | agent | pyrosulfite | | | | | | | | | |
| | Light | Calcium carbonate | | 1 | | | | | | | |
| | scattering | Magnesium | | | 1 | | | | | | |
| | agent | carbonate | | | | | | | | | |
| | | Titanium dioxide | | | | 1 | 0.5 | 0.1 | 1 | 1 | 1 |

| | Total | 100 | 100 | 100 | 100 | 100 | 100 | 100 | 100 | 100 |
|---|---|---|---|---|---|---|---|---|---|---|
| Amount of water added to 100 parts by mass of | | 140 | 140 | 140 | 140 | 140 | 140 | 140 | 140 | 140 |
| powder materials (parts by mass) | | | | | | | | | | |
| Compositional | Vegetable protein | 42 | 41.58 | 41.58 | 41.58 | 41.79 | 41.958 | 41.37 | 41.16 | 41.5758 |
| makeup of meat- | Maillard reaction inhibiting | 0 | 0 | 0 | 0 | 0 | 0 | 0.21 | 0.42 | 0.0042 |
| like food product | agent | | | | | | | | | |
| (mass %) | Light scattering agent | 0 | 0.42 | 0.42 | 0.42 | 0.21 | 0.042 | 0.42 | 0.42 | 0.42 |
| | Water (moisture content) | 58 | 58 | 58 | 58 | 58 | 58 | 58 | 58 | 58 |
| | Total | 100 | 100 | 100 | 100 | 100 | 100 | 100 | 100 | 100 |

| | | | | | | | | | |
|---|---|---|---|---|---|---|---|---|---|
| L* value of uncooked meat-like food product | 65.6 | 70.0 | 67.9 | 79.9 | 74.9 | 69.9 | 87.7 | 82.2 | 81.9 |
| L* value difference of uncooked meat-like food | — | 4.4 | 2.3 | 14.3 | 9.3 | 4.3 | 22.1 | 16.6 | 16.3 |
| product | | | | | | | | | |
| L* value of deep-fried meat-like food product | 65.7 | 70.1 | 68.0 | 80.0 | 75.0 | 70.0 | 87.8 | 82.3 | 82.0 |
| Appearance of deep-fried meat-like food product | 1.0 | 3.2 | 3.2 | 4.2 | 4.1 | 4.0 | 4.6 | 4.4 | 4.4 |
| (perfect score: 5 points) | | | | | | | | | |
| Texture of deep-fried meat-like food product | 3.5 | 3.5 | 3.5 | 3.5 | 3.5 | 3.5 | 4.3 | 3.4 | 3.5 |
| (perfect score: 5 points) | | | | | | | | | |
| Production stability | A | A | A | A | A | A | A | A | A |

Note 1:
“—” in the table indicates that no measurement was performed.

TABLE 3

| | | | Comparative | | | | | | | |
|---|---|---|---|---|---|---|---|---|---|---|
| | | | Example | Example | | | | | | |
| | | | 2 | 25 | 26 | 27 | 28 | 29 | 30 | 31 |
| Powder materials | Vegetable protein | Soy bean protein | 40 | 40 | 40 | 40 | 40 | 40 | 40 | 40 |
| (parts by mass) | | Wheat protein | 40 | Balance | Balance | Balance | Balance | Balance | Balance | Balance |
| | | Green pea protein | 20 | 20 | 20 | 20 | 20 | 20 | 20 | 20 |
| | Maillard reaction | Citric acid | | 0.5 | | | | 0.5 | | |
| | inhibiting agent | Catechin | | | 1 | | | | 1 | |
| | | Sodium | | | | 0.01 | | | | 0.01 |
| | | pyrosulfite | | | | | | | | |
| | Light scattering | Titanium dioxide | | | | | 1 | 1 | 1 | 1 |
| | agent | | | | | | | | | |

| | Total | 100 | 100 | 100 | 100 | 100 | 100 | 100 | 100 |
|---|---|---|---|---|---|---|---|---|---|
| Amount of water added to 100 parts by mass of powder | | 140 | 140 | 140 | 140 | 140 | 140 | 140 | 140 |
| materials (parts by mass) | | | | | | | | | |
| Compositional | Vegetable protein | 42 | 41.79 | 41.58 | 41.9958 | 41.58 | 41.37 | 41.16 | 41.5758 |
| makeup of meat- | Maillard reaction inhibiting agent | 0 | 0.21 | 0.42 | 0.0042 | 0 | 0.21 | 0.42 | 0.0042 |
| like food product | Light scattering agent | 0 | 0 | 0 | 0 | 0.42 | 0.42 | 0.42 | 0.42 |
| (mass %) | Water (moisture content) | 58 | 58 | 58 | 58 | 58 | 58 | 58 | 58 |
| | Total | 100 | 100 | 100 | 100 | 100 | 100 | 100 | 100 |

| | | | | | | | | |
|---|---|---|---|---|---|---|---|---|
| pH of uncooked meat-like food product | 7.1 | 6.0 | — | — | — | 6.0 | — | — |
| L* value of uncooked meat-like food product | 66.5 | 76.9 | 70.3 | 73.8 | 82.1 | 93.9 | 87.6 | 87.1 |
| L* value difference of uncooked meat-like food product | — | 10.4 | 3.8 | 7.3 | 15.6 | 27.4 | 21.1 | 20.6 |
| L* value of deep-fried meat-like food product | 66.6 | 77.0 | 70.4 | 73.9 | 82.2 | 94.0 | 87.7 | 87.2 |
| Appearance of deep-fried meat-like food product | 1.2 | 4.1 | 3.6 | 4.0 | 4.4 | 4.9 | 4.6 | 4.6 |
| (perfect score: 5 points) | | | | | | | | |
| Texture of deep-fried meat-like food product | 3.8 | 4.6 | 3.7 | 3.8 | 3.8 | 4.6 | 3.7 | 3.8 |
| (perfect score: 5 points) | | | | | | | | |
| Production stability | A | A | A | A | A | A | A | A |

Note 1:
“—” in the table indicates that no measurement was performed.

As shown in Tables 1 to 3, since each of the Examples contained at least one type of visual effect improving agent selected from Maillard reaction inhibiting agents and light scattering agents, and either had an L* value of from 60 to 95 in an uncooked state or had an L* value difference of from 2 to 30 in an uncooked state, the Examples had goods results in terms of similarity to the appearance of livestock meat, compared to the Comparative Examples which did not satisfy these conditions.

It should be noted that, when the expert panelists ate the deep-fried foods using the meat-like food products of the respective Examples, the results were that the flavor of the Examples, except for Examples 1 and 9, compared favorably with that of the deep-fried food using livestock meat. In Example 1, slight sourness was perceived, and in Example 9, slight acridness was perceived, but these were at a practically acceptable level.

### INDUSTRIAL APPLICABILITY

The meat-like food product of the present invention has an appearance and flavor/texture similar to that of livestock meat and is useful as a meat substitute, despite using a vegetable protein.

Herein, “livestock meat”, i.e., livestock meat which is a comparison target for the meat-like food product of the present invention, refers to livestock meat in an edible state, and typically refers to livestock meat in a state subjected to cooking by heating, such as deep-frying, boiling, grilling, etc. Further, the type of livestock meat is not particularly limited, and examples may include beef, pork, chicken, mutton/lamb, rabbit meat, poultry meat, etc.

1. A meat-like food product comprising:
a vegetable protein; and
at least one type of visual effect improving agent selected from Maillard reaction inhibiting agents and light scattering agents, wherein
in an uncooked state, the meat-like food product has a moisture content of from 40 to 90 mass % and an L* value of from 60 to 95.

2. A meat-like food product comprising:
a vegetable protein; and
at least one type of visual effect improving agent selected from Maillard reaction inhibiting agents and light scattering agents, wherein
in an uncooked state, the meat-like food product has a moisture content of from 40 to 90 mass %, and
the meat-like food product has a larger L* value in an uncooked state compared to a control product, and a difference in L* value between the meat-like food product and the control product is from 2 to 30, the control product being an uncooked product that does not contain the visual effect improving agent, contains water and a same type of vegetable protein as the vegetable protein contained in the meat-like food product, and has a same moisture content as the meat-like food product.

3. The meat-like food product according to claim 1, wherein
the Maillard reaction inhibiting agent is at least one type selected from organic acids, vitamins, polyphenols, amino acids, and reducing agents, and
a content of the Maillard reaction inhibiting agent is from 0.01 to 3 mass % with respect to a total mass of the meat-like food product.

4. The meat-like food product according to claim 1, wherein
the light scattering agent is at least one type selected from inorganic salts, and
a content of the light scattering agent is from 0.01 to 3 mass % with respect to a total mass of the meat-like food product.

5. A method for producing the meat-like food product according to claim 1, the method comprising
a step of extruding, using an extruder, a raw material containing the vegetable protein, the visual effect improving agent, and water.

6. A method for improving appearance of a meat-like food product containing a vegetable protein and having a moisture content of from 40 to 90 mass % in an uncooked state,
the method comprising
mixing, to the meat-like food product, at least one type of visual effect improving agent selected from Maillard reaction inhibiting agents and light scattering agents, to increase an L* value of the meat-like food product in an uncooked state by 2 to 30 compared to a state in which the visual effect improving agent has not been mixed.
